(19) United States
(12) Patent Application Publication
(10) Pub. No.: US 2024/0186577 A1
(43) Pub. Date: Jun. 6, 2024

(54) ELECTROLYTE FOR LITHIUM SECONDARY BATTERY, AND LITHIUM SECONDARY BATTERY INCLUDING THE SAME

(71) Applicant: SAMSUNG SDI CO., LTD., Yongin-si (KR)

(72) Inventors: Sangwoo Park, Yongin-si (KR); Wonseok Cho, Yongin-si (KR); Sanghyung Kim, Yongin-si (KR); Pavel SHATUNOV, Yongin-si (KR); Olga TSAY, Yongin-si (KR); Myungheui Woo, Yongin-si (KR); Hyejin Park, Yongin-si (KR); Sanghoon Kim, Yongin-si (KR); Bokyung Ryu, Yongin-si (KR)

(21) Appl. No.: 18/481,158

(22) Filed: Oct. 4, 2023

(30) Foreign Application Priority Data
Nov. 16, 2022 (KR) 10-2022-0153812

(51) Int. Cl. H01M 10/0567; C07F 9/6578; H01M 10/0525; H01M 10/0568; H01M 10/0569

(52) U.S. Cl. CPC H01M 10/0567; C07F 9/6578; H01M 10/0525; H01M 10/0568; H01M 10/0569; H01M 2300/004

(57) ABSTRACT

An electrolyte for a lithium secondary battery and a lithium secondary battery including the same are provided. The electrolyte may include a lithium salt, an organic solvent, and an additives (e.g., sulfolane, cyclic phosphate, cyclic phosphite) that form a cathode electrolyte interface film to protect the surface of a positive electrode. Utilization of the additives may improve cycle-life characteristics and suppress or reduce increases to resistance during high-temperature storage of the lithium secondary battery.

### CROSS-REFERENCE TO RELATED APPLICATION

The present application claims priority to and the benefit of Korean Patent Application No. 10-2022-0153812, filed on Nov. 16, 2022, in the Korean Intellectual Property Office, the entire content of which is incorporated herein by reference.

### BACKGROUND

### 1. Field

One or more embodiments of the present disclosure relate to an electrolyte for a lithium secondary battery and a lithium secondary battery including the same.

### 2. Description of the Related Art

Lithium secondary batteries have three or more times higher energy density per unit weight than existing lead-acid batteries, nickel-cadmium batteries, nickel-metal hydride batteries, and nickel-zinc batteries and are capable of being charged at a high speed.

However, if (e.g., when) organic electrolytes are utilized as electrolytes for lithium secondary batteries, a lifetime (lifespan) and high-temperature stability of lithium secondary batteries may be degraded due to side reactions between positive/negative electrodes and the electrolyte. In order to compensate for this point, additives are utilized in electrolytes for lithium secondary batteries. However, the additives that have been utilized do not provide a sufficient lifetime and high-temperature stability for the secondary battery at a high temperature. Therefore, it is desirable to develop an electrolyte for a lithium secondary battery capable of providing a sufficient lifetime and high-temperature stability of a secondary battery at a high temperature, and a lithium secondary battery including the same.

### SUMMARY

One or more aspects of embodiments are directed toward an electrolyte for a lithium secondary battery including a novel electrolyte additive.

One or more aspects of embodiments are directed toward a lithium secondary battery including the electrolyte.

Additional aspects will be set forth in part in the description which follows and, in part, will be apparent from the description, or may be learned by practice of the presented embodiments of the disclosure.

According to an embodiment, provided is an electrolyte for a lithium secondary battery including a lithium salt, an organic solvent, and an additive represented by Formula 1 or Formula 2.

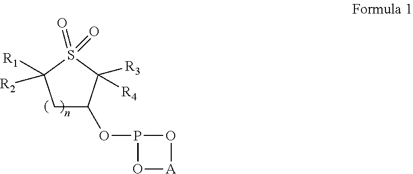

In Formula 1, A may be —[C(R₅)(R₆)]ₘ—, R₁ to R₆ may each independently be hydrogen, a substituted or unsubstituted C1-C20 alkyl group, a substituted or unsubstituted C1-20 alkoxy group, a substituted or unsubstituted C2-C20 alkenyl group, a substituted or unsubstituted C3-C20 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, n may be an integer of 1 or 2, and m may be an integer from 1 to 3.

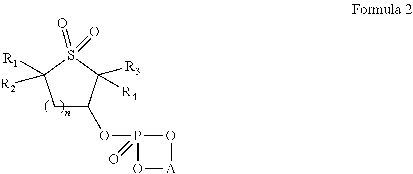

In Formula 2, A may be —[C(R₅)(R₆)]ₘ—, R₁ to R₆ may each independently be hydrogen, a substituted or unsubstituted C1-C20 alkyl group, a substituted or unsubstituted C1-20 alkoxy group, a substituted or unsubstituted C2-C20 alkenyl group, a substituted or unsubstituted C3-C20 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, n may be an integer of 1 or 2, and m may be an integer from 1 to 3.

According to an embodiment, provided is a lithium secondary battery which includes a positive electrode including a positive electrode active material, a negative electrode including a negative electrode active material, and the electrolyte provided between the positive electrode and the negative electrode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a lithium secondary battery according to one or more embodiments of the present disclosure;

FIG. 2A shows a change in direct current internal resistance (DC-IR) increase rate in lithium secondary batteries manufactured according to Manufacturing Examples 1 to 6 and Comparative Manufacturing Example 1;

FIG. 2B shows a change in DC-IR increase rate in lithium secondary batteries manufactured according to Manufacturing Example 3, Comparative Manufacturing Example 2, and Comparative Manufacturing Example 3;

FIG. 3A shows a change in discharge capacity according to the number of cycles in the lithium secondary batteries manufactured according to Manufacturing Examples 1 to 6 and Comparative Manufacturing Example 1;

FIG. 3B shows a change in discharge capacity according to the number of cycles in lithium secondary batteries manufactured according to Manufacturing Example 3 and Comparative Manufacturing Example 2 and 3;

FIG. 4A shows high-temperature life characteristics in the lithium secondary batteries manufactured according to Manufacturing Examples 1 to 6 and Comparative Manufacturing Example 1; and

FIG. 4B shows high-temperature life characteristics in the lithium secondary batteries manufactured according to Manufacturing Example 3 and Comparative Manufacturing Examples 2 and 3.

### DETAILED DESCRIPTION

Reference will now be made in more detail to embodiments, examples of which are illustrated in the accompanying drawings, wherein like reference numerals refer to like elements throughout, and duplicative descriptions thereof may not be provided. In this regard, the present embodiments may have different forms and should not be construed as being limited to the descriptions set forth herein. Accordingly, the embodiments are merely described, by referring to the drawings, to explain aspects of the present description. As utilized herein, the term “and/or” includes any and all combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

The terminology utilized herein describes embodiments only, and is not intended to limit the present disclosure. The singular expression includes the plural expression unless the context clearly dictates otherwise. It will be understood that, although the terms first, second, etc. may be used herein to describe various elements, these elements should not be limited by these terms. These terms are only used to distinguish one element from another element. Thus, a first element could be termed a second element without departing from the teachings of the present disclosure. Similarly, a second element could be termed a first element.

Unless otherwise defined, all chemical, technical and scientific terms utilized herein have the same meanings as commonly understood by one of ordinary skill in the art to which the disclosure. In case of conflict, the present specification, including definitions, will control.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the drawings. For example, if (e.g., when) the device in the drawings is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Although any methods and materials similar or equivalent to those described herein can be utilized in the practice or testing of embodiments of the disclosure, suitable methods and materials are described herein. A singular form may include a plural form if (e.g., when) there is no clearly opposite meaning in the context.

As utilized herein, it is to be understood that the terms such as “includes,” “including,” “include,” “having,” “has,” “have,” “comprises,” “comprising,” and/or “comprise,” are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added.

It will be understood that the term “a combination thereof” as utilized herein refers to a mixture or combination inclusive of two or more components.

As utilized herein, the term “and/or” includes any and all combinations of one or more of the associated listed items. As utilized herein, the term “or” refers to the term “and/or.” As utilized herein, the expression “at least one species,” “at least one,” or “one or more” in front of elements refers to that the expression may complement the entire list of elements and does not refer to that the expression may complement individual elements described above.

In the drawings, the thickness of layers, films, panels, regions, and/or the like are exaggerated for clarity. Like reference numerals designate like elements throughout, and duplicative descriptions thereof may not be provided the specification. It will be understood that if (e.g., when) an element such as a layer, film, region, or substrate is referred to as being “on” another element, it can be directly on the other element or intervening elements may also be present. It will be understood that, although the terms “first,” “second,” and “third” may be utilized herein to describe one or more suitable elements, elements should not be limited by these terms. These terms are only utilized to distinguish one element from another element. As used herein, singular forms such as “a,” “an,” and “the” are intended to include the plural forms as well, unless the context clearly indicates otherwise.

As used herein, the terms “use,” “using,” and “used” may be considered synonymous with the terms “utilize,” “utilizing,” and “utilized,” respectively.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” means that any additional components will not materially affect the chemical, physical, optical or electrical properties of the semiconductor film.

Further, in this specification, the phrase “on a plane,” or “plan view,” means viewing a target portion from the top, and the phrase “on a cross-section” means viewing a cross-section formed by vertically cutting a target portion from the side.

In the drawing, the thickness of layers, films, panels, regions, etc., are exaggerated for clarity and like reference numerals designate like elements throughout, and duplicative descriptions thereof may not be provided in the specification. It will be understood that if (e.g., when) an element such as a layer, film, region, or substrate is referred to as being “on” another element, it can be directly on the other element or intervening elements may also be present. In contrast, if (e.g., when) an element is referred to as being “directly on” another element, there are no intervening elements present.

In some embodiments, “layer” as utilized herein includes not only a shape formed on the whole surface if (e.g., when) viewed from a plan view, but also a shape formed on a partial surface.

In some embodiments, the terms “about” and “substantially” utilized throughout the present specification refer to the meaning of the mentioned with inherent preparation and material permissible errors if (e.g., when) presented, and are utilized in the sense of being close to or near that value. They are utilized to help understand the present disclosure and to prevent or reduce unconscientious infringers from unfairly exploiting the disclosure where accurate or absolute values are mentioned.

As utilized herein, if (e.g., when) a definition is not otherwise provided, “substituted” refers to replacement of hydrogen of a compound by a substituent selected from among a deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, and/or combinations thereof.

As utilized herein, if (e.g., when) a definition is not otherwise provided, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In some embodiments, in specific examples of the present disclosure, “substituted” refers to replacement of at least one hydrogen of a substituent or a compound by deuterium, a halogen, a C1 to C20 alkyl group, a C6 to C30 aryl group, a C1 to C10 fluoroalkyl group, or a cyano group. In some embodiments, in specific examples of the present disclosure, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group. In some embodiments, in specific examples of the present disclosure, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

Expressions such as C1 to C30 refer to that the number of carbon atoms is 1 to 30.

Hereinafter, an electrolyte for a lithium secondary battery and a lithium secondary battery including the same will be described in more detail with reference to embodiments and drawings of the disclosure. It should be understood by one of ordinary skill in the art that these embodiments provided only for more specific illustration of the disclosure and are not to be construed as limiting the scope of the disclosure.

### Electrolyte

If (e.g., when) lithium transition metal oxide, which includes nickel and at least one transition metal other than nickel and in which a content (e.g., amount) of nickel is, for example, about 80 mol % or more with respect to the total number of moles of the transition metal, is utilized as a positive electrode active material, it is possible to manufacture a lithium secondary battery having high power and high capacity. However, because lithium transition metal oxide having a high nickel content (e.g., amount) has an unstable surface structure, during a charging/discharging process of a battery, a gas generation amount is increased due to side reactions, and elution of transition metals such as nickel may be further enhanced. Accordingly, in a lithium secondary battery utilizing lithium transition metal oxide having a high nickel content (e.g., amount) as a positive electrode active material, life characteristics may be degraded, and resistance is increased at a high temperature. Thus, it is desirable (or there is a need) to improve stability at a high temperature.

An electrolyte for a lithium secondary battery according to one or more embodiments may include a lithium salt, an organic solvent, and an additive represented by Formula 1 or Formula 2.

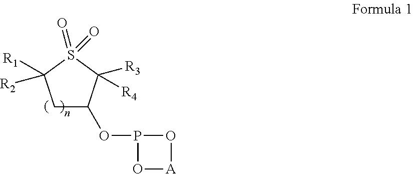

In Formula 1, A may be —[C(R₅)(R₆)]ₘ—, R₁ to R₆ may each independently be hydrogen, a substituted or unsubstituted C1-C20 alkyl group, a substituted or unsubstituted C1-20 alkoxy group, a substituted or unsubstituted C2-C20 alkenyl group, a substituted or unsubstituted C3-C20 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, n may be an integer of 1 or 2, and m may be an integer from 1 to 3.

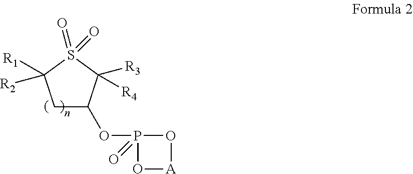

In Formula 2, A may be —[C(R₅)(R₆)]ₘ—, R₁ to R₆ may each independently be hydrogen, a substituted or unsubstituted C1-C20 alkyl group, a substituted or unsubstituted C1-20 alkoxy group, a substituted or unsubstituted C2-C20 alkenyl group, a substituted or unsubstituted C3-C20 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, n may be an integer of 1 or 2, and m may be an integer from 1 to 3.

The additive represented by Formula 1 may include a sulfolane group and a cyclic phosphite group. The additive represented by Formula 2 may include sulfolane and cyclic phosphate groups. The additives undergo an oxidative decomposition during formation to form a cathode electrolyte interface (CEI) film on a surface of a positive electrode and protect the surface of the positive electrode, thereby contributing to structural stabilization of the positive electrode. In one or more embodiments, phosphite of Formula 1 or a phosphate portion of Formula 2 may be oxidatively decomposed to form a film having a polymerized form, thereby protecting a positive electrode and contributing to structural stabilization of the positive electrode. In some embodiments, because the additives of Formulas 1 and 2 include a sulfolane group having excellent or suitable thermal stability, the thermal stability of a CEI film itself may be improved, thereby improving high-temperature characteristics.

In Formulas 1 and 2, if (e.g., when) a sulfolane ring is a 6-membered ring, a phosphite or phosphate substituent may be bonded to a para or meta position of the sulfolane ring. If (e.g., when) the sulfolane ring is a 5-membered ring, the phosphite or phosphate substituent may be bonded to the meta position of the sulfolane ring. If (e.g., when) the phosphite or phosphate substituent connected to the sulfolane ring is bonded to the above-described position, it is possible to obtain excellent or suitable effects of reducing a resistance increase rate and a gas generation amount during high-temperature storage and increasing a high-temperature lifetime. If (e.g., when) the phosphite or phosphate substituent connected to the sulfolane ring is bonded to a position other than the above-described position, it is chemically very unstable, and thus synthesis itself is complicated (e.g., not easy).

The additive represented by Formula 1 or Formula 2 may include both (e.g., simultaneously) sulfolane and phosphite or may include both (e.g., simultaneously) sulfolane and phosphate structures. If (e.g., when) a mixture of sulfolane and phosphite or a mixture of sulfolane and phosphate is utilized, because an oxidation or reduction reaction does not proceed well at a general driving voltage, sulfolane may be electrochemically inactive. Thus, it may be difficult to add the mixture of sulfolane and phosphite or the mixture of sulfolane and phosphate to a positive electrode as a film component.

However, in the electrolyte according to one or more embodiments, the additive represented by Formula 1 or Formula 2 described above may form a composite film having a form in which sulfolane capable of improving thermal stability is bonded to a film component formed if (e.g., when) phosphite or phosphate is decomposed. As a result, as compared with a case in which a mixture of sulfolane and phosphite or a mixture of sulfolane and phosphate is utilized, a CEI film with improved thermal stability may be formed on a positive electrode. Because the electrolyte for a lithium secondary battery according to one or more embodiments includes the additive represented by Formula 1, a CEI film may be formed on a positive electrode to form an excellent or suitable high heat-resistant film on a surface of the positive electrode, thereby serving to prevent or reduce side reactions such as electrolyte decomposition. Accordingly, in a lithium secondary battery including such an electrolyte, it is possible to reduce an amount of gas generated due to a decomposition reaction of the electrolyte inside the lithium secondary battery during high-temperature storage and suppress or reduce an increase in resistance, thereby improving life characteristics.

The additive represented by Formula 1 or Formula 2 may be, for example, an additive represented by Formula 3, Formula 3-1, Formula 3-2, Formula 3-3, Formula 4, Formula 4-1, Formula 4-2, or Formula 4-3.

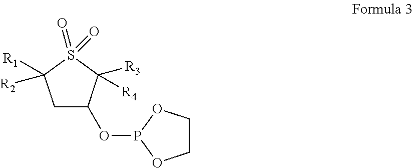

In Formula 3, R₁ to R₄ may each independently be hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

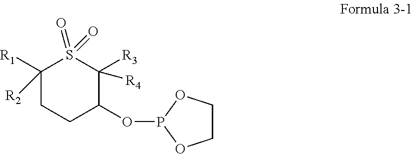

In Formula 3-1, R₁ to R₄ may each independently be hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

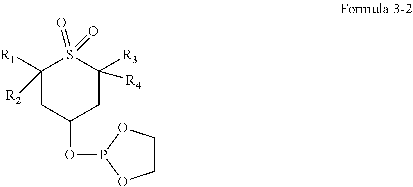

In Formula 3-2, R₁ to R₄ may each independently be hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

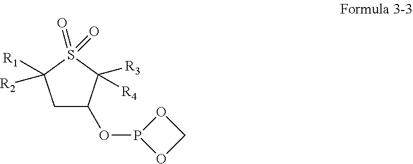

In Formula 3-3, R₁ to R₄ may each independently be hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

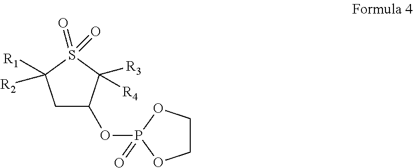

In Formula 4, R₁ to R₄ may each independently be hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

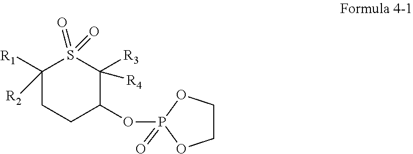

In Formula 4-1, R₁ to R₄ may each independently be hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

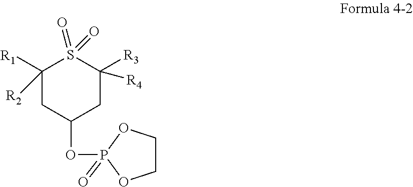

In Formula 4-2, R₁ to R₄ may each independently be hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

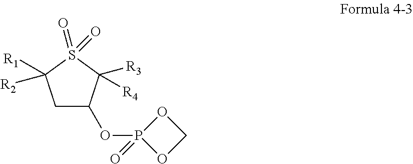

In Formula 4-3, R₁ to R₄ may each independently be hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

In Formulas above, R₁ to R₄ may all be, for example, hydrogen.

The additive represented by Formula 1 may be, for example, at least one selected from among Compounds A to H.

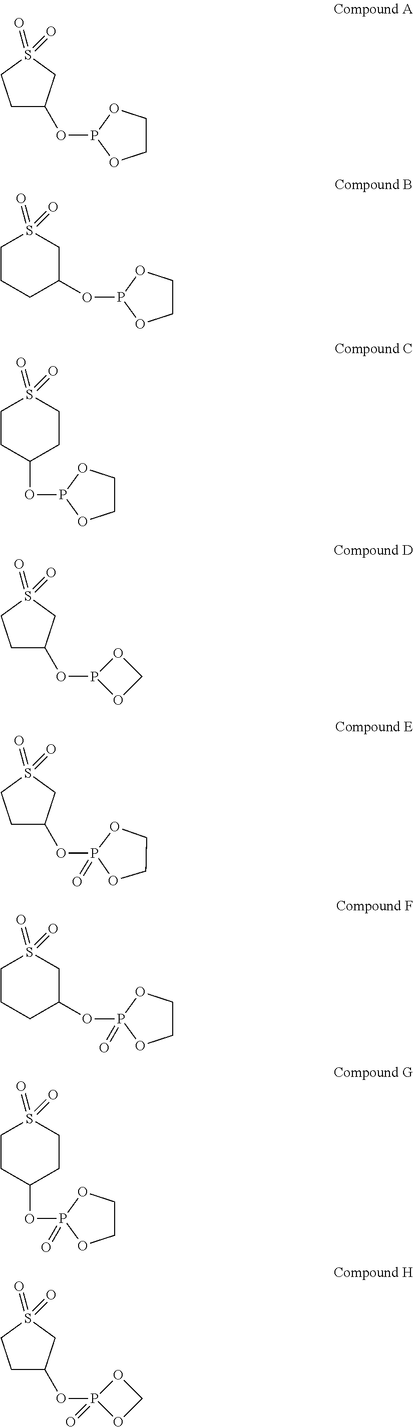

A content (e.g., amount) of the additive represented by Formula 1 or Formula 2 may be in a range of about 0.1 wt % to about 10 wt %, about 0.1 wt % to about 5 wt %, about 0.1 wt % to about 5 wt %, or about 0.1 wt % to about 2 wt % with respect to about 100 wt % of the total weight of the electrolyte. If (e.g., when) the content (e.g., amount) of the additive is within the above range, a positive electrode may be protected in a high temperature environment to increase a lifetime of the positive electrode and reduce a gas generation amount and a resistance increase rate during high-temperature storage.

According to one or more embodiments, the lithium salt may include at least one selected from among LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), LiPO₂F₂, and compounds represented by Formulas 5 to 8, but one or more embodiments are not limited thereto. Any material suitable as a lithium salt in the art may be utilized.

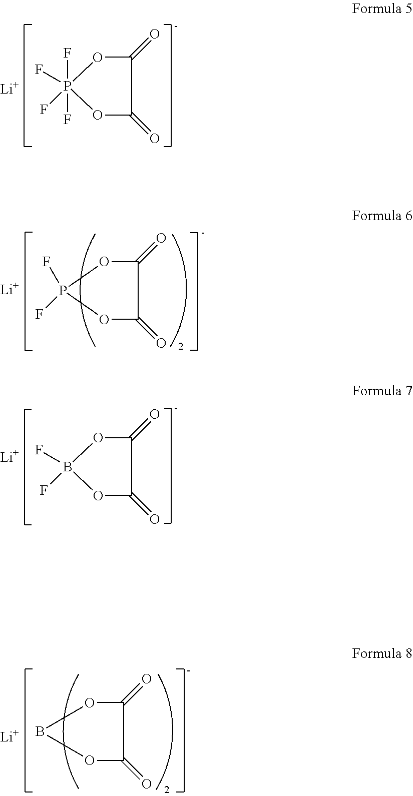

A concentration of the lithium salt in the electrolyte may be in a range of about 0.1 M to about 5.0 M, for example, a range of about 0.1 M to about 3.0 M or about 0.1 to about 2.0 M. If (e.g., when) the concentration of the lithium salt is within the above range, it is possible to obtain further improved characteristics of a lithium secondary battery.

The organic solvent may be at least one selected from among a carbonate-based solvent, an ester-based solvent, an ether-based solvent, and a ketone-based solvent.

The carbonate-based solvent may include ethyl methyl carbonate (EMC), methyl propyl carbonate (MPC), ethyl propyl carbonate (EPC), dimethyl carbonate (DMC), diethyl carbonate (DEC), dipropyl carbonate (DPC), propylene carbonate (PC), ethylene carbonate (EC), butylene carbonate (BC), and/or the like.

The ester-based solvent may include methyl propionate, ethyl propionate, ethyl butyrate, methyl acetate, ethyl acetate, n-propyl acetate, dimethyl acetate, gamma butyrolactone, decanolide, gamma valerolactone, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone and/or the like. The nitrile-based solvent may include acetonitrile (AN), succinonitrile (SN), adiponitrile, and/or the like.

Other solvents included in the electrolyte may include dimethylsulfoxide, dimethylformamide, dimethylacetamide, tetrahydrofuran, and/or the like, but one or more embodiments are not necessarily limited thereto. Any material usable as an organic solvent in the art may be utilized. For example, the organic solvent may include a mixed solvent of about 50 vol % to about 95 vol % of chain carbonate and about 5 vol % to about 50 vol % of cyclic carbonate, for example, a mixed solvent of about 70 vol % to about 95 vol % of chain carbonate and about 5 wt % to about 30 vol % of cyclic carbonate. For example, the organic solvent may be a mixed solvent of three or more organic solvents.

According to one or more embodiments, the organic solvent may include at least one selected from among EMC, MPC, EPC, DMC, DEC, DPC, PC, EC, fluoroethylene carbonate (FEC), vinylene carbonate (VC), vinylethylene carbonate (VEC), butylene carbonate, ethyl propionate, ethyl butyrate, dimethyl sulfoxide, dimethylformamide, dimethylacetamide, gamma-valerolactone, gamma-butyrolactone, and tetrahydrofuran, but one or more embodiments are not limited thereto. Any material suitable as an organic solvent in the art may be utilized.

The electrolyte according to one or more embodiments may be in a liquid or gel state. The electrolyte may be prepared by adding the lithium salt and the above-described additives to the organic solvent.

A lithium secondary battery according to one or more embodiments may include a positive electrode including a positive electrode active material, a negative electrode including a negative electrode active material; and the above-described electrolyte provided between the positive electrode and the negative electrode.

In the lithium secondary battery, by utilizing the electrolyte that includes the described additive for an electrolyte, an increase in initial resistance of the lithium secondary battery may be suppressed or reduced, generation of gas due to a side reaction may be suppressed or reduced, and life characteristics may be improved.

The positive electrode active material may include lithium transition metal oxide including nickel and a transition metal other than nickel. A content (e.g., amount) of nickel in the lithium transition metal oxide including nickel and a transition metal other than nickel may be about 60 mol % or more, for example, about 75 mol % or more, for example, about 80 mol % or more, for example, about 85 mol % or more, or for example, or about 90 mol % or more with respect to the total number of moles of the transition metal.

For example, the lithium transition metal oxide may be a compound represented by Formula 9:

LiₐNiₓCo_{y}M_{z}O_{2-b}A_{b}. Formula 9

In Formula 9, 1.0≤a≤1.2, 0≤b≤0.2, 0.6≤x<1, 0≤y≤0.03, 0<z≤0.3, x+y+z=1, M may be at least one selected from among manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), and boron (B), and A may be F, S, Cl, Br, or a combination thereof.

In Formula 9, for example, 0.7≤x<1, 0<y≤0.3, 0<z≤0.3; 0.8≤x<1, 0<y≤0.3, and 0<z≤0.3; 0.8≤x<1, 0<y≤.2, and 0<z≤0.2; 0.83≤x<0.97, 0<y≤0.15, and 0<z≤0.15; or 0.85≤x<0.95, 0<y≤0.1, and 0<z≤0.1.

For example, the lithium transition metal oxide may be at least one selected from among compounds represented by Formulas 10 and 11.

LiNiₓCo_{y}Mn_{z}O₂ Formula 10

In Formula 10, 0.6≤x≤0.95, 0<y≤0.2, and 0<z≤0.1. For example, 0.7≤x≤0.95, 0<y≤0.3, and 0<z≤0.3.

LiNiₓCo_{y}Al_{z}O₂ Formula 11

In Formula 11, 0.6≤x≤0.95, 0<y≤0.2, and 0<z≤0.1. For example, 0.7≤x≤0.95, 0<y≤0.3, and 0<z≤0.3. For example, 0.8≤x≤0.95, 0<y≤0.3, and 0<z≤0.3. For example, 0.82≤x≤0.95, 0<y≤0.15, and 0<z≤0.15. For example, 0.85≤x≤0.95, 0<y≤0.1, and 0<z≤0.1.

For example, the lithium transition metal oxide may be LiNi_{0.6}Co_{0.2}Mn_{0.2}O₂, LiNi_{0.88}Co_{0.08}Mn_{0.04}O₂, LiNi_{0.8}Co_{0.15}Mn_{0.05}O₂, LiNi_{0.8}Co_{0.01}Mn_{0.01}O₂, LiNi_{0.88}Co_{0.01}Mn_{0.02}O₂, LiNi_{0.8}Co_{0.15}Al_{0.05}O₂, LiNi_{0.8}Co_{0.1}Mn_{0.2}O₂, or LiNi_{0.88}Co_{0.1}Al_{0.02}O₂.

According to one or more embodiments, the positive electrode active material may include at least one active material selected from among Li—Ni—Co—Al (NCA), Li—Ni—Co—Mn (NCM), lithium cobalt oxide (LiCoO₂), lithium manganese oxide (LiMnO₂), lithium nickel oxide (LiNiO₂), and lithium iron phosphate (LiFePO₄).

The negative electrode active material may include at least one selected from among a silicon-based compound, a carbon-based material, a composite of a silicon-based compound and a carbon-based compound, and silicon oxide (SiOₓ) (wherein 0<x<2). The silicon-based compound may include silicon particles, silicon alloy particles, and/or the like.

A size of the silicon-based compound may be less than about 200 nm, for example, in a range of about 10 nanometer (nm) to about 150 nm. The term “size” may refer to an average particle diameter if (e.g., when) the silicon-based compound is spherical and may refer to an average long (or major) axis length if (e.g., when) the silicon-based compound is non-spherical.

If (e.g., when) the size of the silicon-based compound is within the described range, life characteristics are excellent or suitable, and thus a lifetime of the lithium secondary battery may be further improved if (e.g., when) the electrolyte according to one or more embodiments is utilized.

The carbon-based material may be crystalline carbon, amorphous carbon, or a mixture thereof. The crystalline carbon may be graphite such as natural graphite or artificial graphite having a non-shaped, plate-like, flake-like, spherical, or fibrous form. The amorphous carbon may be soft carbon (low-temperature fired carbon), hard carbon, mesophase pitch carbide, or fired coke.

The composite of the silicon-based compound and the carbon-based compound may be a composite having a structure in which silicon particles are arranged on a carbon-based compound, a composite having a structure in which silicon particles are included on a surface of a carbon-based compound and inside the carbon-based compound, or a composite in which silicon particles are coated with a carbon-based compound and included inside the carbon-based compound. In the composite of the silicon-based compound and the carbon-based compound, the carbon-based compound may be graphite, graphene, graphene oxide, or a combination thereof.

The composite of the silicon-based compound and the carbon-based compound may be an active material obtained by dispersing silicon nanoparticles having an average particle diameter of about 200 nm or less on carbon compound particles and then coating the silicon nanoparticles with carbon or an active material in which silicon (Si) particles are present on graphite and inside graphite. The composite of the silicon-based compound and the carbon-based compound may have an average secondary particle diameter of about 5 micrometer (μm) to about 20 μm. An average particle diameter of the silicon nanoparticles may be about 5 nm or more, for example, about 10 nm or more, for example, about 20 nm or more, for example, about 50 nm or more, or for example, about 70 nm or more. The average particle diameter of the silicon nanoparticles may be about 200 nm or less, about 150 nm or less, about 100 nm or less, about 50 nm or less, about 20 nm or less, or about 10 nm or less. For example, the average particle diameter of the silicon nanoparticles may be in a range of about 100 nm to about 150 nm.

The composite of the silicon-based compound and the carbon-based compound may have an average secondary particle diameter of about 5 μm to about 18 μm, for example, about 7 μm to about 15 μm, or for example, about 10 μm to about 13 μm.

As another example of the composite of the silicon-based compound and the carbon-based compound, a porous silicon composite cluster disclosed in Korean Application Publication No. 10-2018-0031585 and a porous silicon composite cluster structure disclosed in Korean Application Publication No. 10-2018-0056395 may be utilized. Korean Application Publication No. 10-2018-0031585 and Korean Application Publication No. 10-2018-0056395 are incorporated herein by reference.

A silicon-carbon-based compound composite according to one or more embodiments may be a porous silicon composite cluster which includes a porous core including a porous silicon composite secondary particle and a shell including second graphene provided on the core, wherein the porous silicon composite secondary particle includes an aggregate of two or more silicon composite primary particles, and the silicon composite primary particle includes silicon, silicon oxide (SiOₓ) (wherein O<x<2) provided on the silicon, and first graphene provided on the silicon oxide.

A silicon-carbon-based compound composite according to one or more embodiments may be a porous silicon composite cluster structure which includes a porous silicon composite cluster including a porous silicon composite secondary particle and a second carbon flake on at least one surface of the porous silicon composite secondary particle. In one or more embodiments, a carbon-based coating film including amorphous carbon is provided on the porous silicon composite cluster. In one or more embodiments, the porous silicon composite secondary particle includes an aggregate of two or more silicon composite primary particles, the silicon composite primary particle includes silicon, silicon oxide (SiOₓ) (wherein O<x<2) on at least one surface of the silicon, and a first carbon flake on at least one surface of the silicon oxide, and the silicon oxide is present in a state of a film, a matrix, or a combination thereof.

The first carbon flake and the second carbon flake may each be present in a state of a film, a particle, a matrix, or a combination thereof. The first carbon flake and the second carbon flake may each be graphene, graphite, a carbon fiber, graphene oxide, and/or the like.

The described composite of the silicon-based compound and the carbon-based compound may be a composite having a structure in which silicon particles are arranged on a carbon-based compound, a composite having a structure in which silicon particles are included on a surface of a carbon-based compound and inside the carbon-based compound, or a composite in which silicon particles are coated with a carbon-based compound and included inside the carbon-based compound. In the composite of the silicon-based compound and the carbon-based compound, the carbon-based compound may be graphite, graphene, graphene oxide, or a combination thereof.

A shape of the lithium secondary battery is not particularly limited, and the lithium secondary battery may include a lithium ion battery, a lithium ion polymer battery, a lithium sulfur battery, and/or the like.

The lithium secondary battery may be manufactured through the following method, which serves as a non-limiting example.

First, a positive electrode is prepared.

For example, a positive electrode active material composition in which a positive electrode active material, a conductive material, a binder, and a solvent are mixed is prepared. The positive electrode active material composition is applied directly on a metal current collector to prepare a positive electrode plate. In some embodiments, the positive electrode active material composition may be cast on a separate support, and then the film peeled from (e.g., off of) the support may be laminated on a metal current collector to prepare the positive electrode plate. The positive electrode is not limited to the forms listed above and may have forms other than the above forms.

As the positive electrode active material, any material, which is commonly utilized as a lithium-containing metal oxide in the art, may be utilized without limitation. For example, at least one composite oxide of lithium and a metal selected from among cobalt, manganese, nickel, and a combination thereof may be utilized. A specific example of the positive electrode active material may include a compound represented by any one of LiₐA_{1-b}B¹_{b}D¹₂ (wherein 0.90≤a≤1.8 and 0≤b≤0.5), LiₐE_{1-b}B¹_{b}O_{2-c}D¹_{c} (wherein 0.90≤a≤1.8, 0≤b≤0.5, and 0≤c≤0.05), LiE_{2-b}B¹_{b}O_{4-c}D¹_{c} (wherein 0≤b≤0.5 and 0≤c≤0.05), LiₐNi_{1-b-c}Co_{b}B¹_{c}D¹_{α} (wherein 0.90≤a≤1.8, 0≤b≤0.05, 0≤c≤0.05, and 0<α≤2), LiₐNi_{1-b-c}Co_{b}B¹_{c}O_{2-α}F¹_{α} (wherein 0.90≤a≤1.8, 0≤b≤0.05, 0≤c≤0.05, and 0<α<2), LiₐNi_{1-b-c}Co_{b}B¹_{c}O_{2-α}F¹₂ (wherein 0.90≤a≤1.8, 0≤b≤0.05, 0≤c≤0.05, and 0<α<2), Li₁Ni_{1-b-c}Mn_{b}B¹_{c}D_{α} (wherein 0.90≤a≤1.8, 0≤b≤0.05, 0≤c≤0.05, and 0<α≤2), LiₐNi_{1-b-c}Mn_{b}B¹_{c}O_{2-α}F¹_{α} (wherein 0.90≤a≤1.8, 0≤b≤0.5, 0≤c≤0.05, and 0<α<2), LiₐNi_{1-b-c}Mn_{b}B¹_{c}O_{2-α}F¹₂ (wherein 0.90≤a≤1.8, 0≤b≤0.05, 0≤c≤0.05, and 0<α<2), LiₐNi_{b}E_{c}G_{d}O₂ (wherein 0.90≤a≤1.8, 0≤b≤0.9, 0≤c≤0.5, and 0.001≤d≤0.1), LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1), LiₐNiG_{b}O₂ (wherein 0.09≤a≤1.8 and 0.001≤b≤0.1), LiₐCoG_{b}O₂ (wherein 0.90≤a≤1.8 and 0.001≤b≤0.1), LiₐMnG_{b}O₂ (wherein 0.90≤a≤1.8 and 0.001≤b≤0.1), LiₐMn₂G_{b}O₄ (wherein 0.90≤a≤1.8 and 0.001≤b≤0.1), QO₂, QS₂, LiQS₂, V₂O₅, LiV₂O₅, LiIO₂, LiNiVO₄, Li_{(3-f}J₂(PO₄)₃ (wherein 0≤f≤2), Li_{(3-f)}Fe₂(PO₄)₃ (wherein 0≤f≤2), and/or LiFePO₄.

In the formulas above, A may be Ni, Co, Mn, or a combination thereof, B¹ may be Al, Ni, Co, Mn, Cr, Fe, Mg, Sr, V, a rare earth element, or a combination thereof, D¹ may be O, F, S, P, or a combination thereof, E may be Co, Mn, or a combination thereof, F¹ may be F, S, P, or a combination thereof, G may be Al, Cr, Mn, Fe, Mg, La, Ce, Sr, V, or a combination thereof, Q may be Ti, Mo, Mn, or a combination thereof, I may be Cr, V, Fe, Sc, Y, or a combination thereof, and J may be V, Cr, Mn, Co, Ni, Cu, or a combination thereof.

For example, LiCoO₂, LiMnₓO₂ₓ (wherein x=1 or 2), LiNi₁₋ₓMnₓO₂ₓ (wherein 0<x<1), LiNi_{1-x-y}CoₓMn_{y}O₂ (wherein 0≤x≤0.5 and 0≤y≤0.5), LiFePO₄, and/or the like may be utilized.

In some embodiments, a compound having a coating layer on a surface of the compound may be utilized, or a mixture of the compound and a compound having a coating layer may be utilized. The coating layer may include a coating element compound of an oxide or hydroxide of a coating element, an oxyhydroxide of the coating element, an oxycarbonate of the coating element, or a hydroxycarbonate of the coating element. A compound constituting the coating layer may be amorphous or crystalline. The coating element included in the coating layer may include Mg, Al, Co, K, Na, Ca, Si, Ti, V, Sn, Ge, Ga, B, As, Zr, or a mixture thereof. In a process of forming the coating layer, any coating method may be utilized as long as the compound may be coated with such elements through a method (for example, a spray coating method or a dipping method) that does not adversely affect physical properties of the positive electrode active material. Because the coating method is suitable well to those who work in the related field, a detailed description thereof will not be provided.

The conductive material may include carbon black, graphite fine particles, and/or the like, but one or more embodiments are not limited thereto. Any material usable as a conductive material in the art may be utilized.

The binder may include at least one selected from among a vinylidene fluoride/hexafluoropropylene copolymer, polyvinylidene fluoride (PVDF), polyacrylonitrile, polymethyl methacrylate, polytetrafluoroethylene, a mixture thereof, or a styrene butadiene rubber-based polymer, but one or embodiments are not limited thereto. Any material usable as a binder in the art may be utilized.

The solvent may include N-methylpyrrolidone, acetone, or water, but one or more embodiments are not limited thereto. Any solvent usable in the art may be utilized.

Contents of the positive electrode active material, the conductive material, the binder, and the solvent are at levels that are commonly utilized in a lithium battery. One or more of the conductive material, the binder, and the solvent may not be provided according to the utilize and configuration of a lithium battery.

Next, a negative electrode is prepared.

For example, a negative electrode active material composition is prepared by mixing a negative electrode active material, a binder, and a solvent. The negative electrode active material composition is applied directly on a metal current collector and dried to prepare a negative electrode plate. In some embodiments, the negative electrode active material composition may be cast on a separate support, and then a film peeled from (e.g., off of) the support may be laminated on a metal current collector to prepare the negative electrode plate.

As the negative electrode active material, any material, which is suitable as a negative electrode active material for a lithium battery in the art, may be utilized. For example, the negative electrode active material may include at least one selected from among a lithium metal, a metal capable of forming an ally with lithium, a transition metal oxide, a non-transition metal oxide, and a carbon-based material.

For example, the metal capable of forming an ally with lithium may be Si, Sn, Al, Ge, Pb, Bi, Sb, a Si—Y alloy (wherein Y is an alkali metal, an alkaline earth metal, a Group 13 element, a Group 14 element, a transition metal, a rare earth element, or a combination thereof and is not Si) or a Sn—Y alloy (wherein Y is an alkali metal, an alkaline earth metal, a Group 13 element, a Group 14 element, a transition metal, a rare earth element, or a combination thereof and is not Sn). The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

For example, the transition metal oxide may be lithium titanium oxide, vanadium oxide, or lithium vanadium oxide.

For example, the non-transition metal oxide may be Sn₂, SiOₓ (wherein 0<x<2), and/or the like.

The carbon-based material may be crystalline carbon, amorphous carbon, or a mixture thereof. The crystalline carbon may be graphite such as non-shaped, plate-shaped, flake-shaped, spherical, or fibrous natural graphite or artificial graphite. The amorphous carbon may be soft carbon (low-temperature fired carbon) or hard carbon, mesophase pitch carbide, fired coke, and/or the like.

Non-limiting examples of a binder for a negative electrode may include one or more suitable types (kinds) of binder polymers such as a polyvinylidene fluoride-hexafluoropropylene copolymer (PVDF-co-HFP), polyvinylidene fluoride, polyacrylonitrile, polymethyl methacrylate, polyvinyl alcohol, carboxylmethylcellulose (CMC), starch, hydroxypropylcellulose, regenerated cellulose, polyvinyl pyrrolidone, tetrafluoroethylene, polyethylene, polypropylene, a polyacrylic acid, an ethylene-propylene-diene monomer (EPDM), a sulfonated EPDM, styrene-butadiene rubber (SBR), fluoro rubber, a poly acrylic acid, a polymer in which hydrogen thereof is substituted with Li, Na or Ca, and one or more suitable copolymers.

The negative electrode active material layer may further include a thickener.

The thickener may include at least one selected from among CMC, carboxyethyl cellulose, starch, regenerated cellulose, ethyl cellulose, hydroxylmethyl cellulose, hydroxylethyl cellulose, hydroxypropyl cellulose, and polyvinyl alcohol. For example, CMC may be utilized.

A content (e.g., amount) of the solvent may be in a range of about 100 parts by weight to about 300 parts by weight with respect to about 100 parts by weight of the total weight of the negative electrode active material. If (e.g., when) the content (e.g., amount) of the solvent is within the above range, an operation of forming the negative electrode active material layer is easy.

If (e.g., when) conductivity is secured, the negative electrode active material layer does not require a conductive material. The negative electrode active material layer may further include a conductive material as needed. As the conductive material, a material is not particularly limited as long as the material has conductivity (e.g., is a conductor) without causing a chemical change in a corresponding battery. For example, the conductive material may include graphite such as natural graphite or artificial graphite, carbon black such as carbon black, acetylene black, Ketjen black, channel black, furnace black, lamp black, or summer black, a conductive fiber such as a carbon fiber or a metal fiber, a conductive tube such as a carbon nanotube, fluorinated carbon, a metal powder such as an aluminum or nickel powder, conductive whiskey such as zinc oxide or potassium titanate, conductive metal oxide such as titanium oxide, a conductive material such as a polyphenylene derivative, and/or the like. The conductive material may be carbon black, and more specifically, may be carbon black having an average particle diameter of several tens of nanometers.

If (e.g., when) the negative electrode active material layer includes a conductive material, a content (e.g., amount) of the conductive material may be in a range of about 0.01 parts by weight to about 10 parts by weight, about 0.01 parts by weight to about 5 parts by weight, or about 0.1 parts by weight to about 2 parts by weight with respect to about 100 parts by weight of the total weight of the negative electrode active material layer.

The negative electrode current collector may be generally prepared to have a thickness of about 3 μm to about 500 μm. As the negative electrode current collector, a material is not particularly limited as long as the material has high conductivity without causing a chemical change in a corresponding battery. For example, the negative electrode current collector may include copper, stainless steel, aluminum, nickel, titanium, carbon subjected to heat treatment, copper or stainless steel which is surface-treated with carbon, nickel, titanium, silver, and/or the like, or an aluminum-cadmium alloy. In some embodiments, similarly to the positive electrode current collector, a fine unevenness may be formed on a surface of the negative electrode current collector to strengthen bonding strength of the negative electrode active material, and the negative electrode current collector may have one or more suitable forms such as a film, a sheet, a foil, a net, a porous body, a foam body, and/or a nonwoven fabric.

Next, a separator to be inserted between the positive electrode and the negative electrode is prepared.

As the separator, any separator commonly utilized in a lithium battery may be utilized. A separator having low resistance to the movement of ions in an electrolyte and an excellent or suitable electrolyte impregnation ability may be utilized. For example, the separator may include at least one selected from among a glass fiber, polyester, Teflon, polyethylene, polypropylene, polytetrafluoroethylene (PTFE), and a combination thereof and may be in the form of a nonwoven fabric or a woven fabric. For example, a windable separator including polyethylene, polypropylene, and/or the like may be utilized in a lithium ion battery, and a separator having an excellent or suitable electrolyte impregnation ability may be utilized in a lithium ion polymer battery. For example, the separator may be prepared according to the following method, which serves as a non-limiting example.

A polymer resin, a filler, and a solvent are mixed to prepare a separator composition. The separator composition may be applied directly on an electrode and dried to form the separator. In some embodiments, the separator composition may be cast on a support, and then a separator film peeled from (e.g., off of) the support may be laminated on an electrode to form the separator.

The polymer resin utilized for preparing the separator is not particularly limited, and any material utilized in a binding material of an electrode plate may be utilized. For example, the polymer resin may include a vinylidene fluoride/hexafluoropropylene copolymer, PVDF, polyacrylonitrile, polymethyl methacrylate, or a mixture thereof.

Next, the above-described electrolyte is prepared.

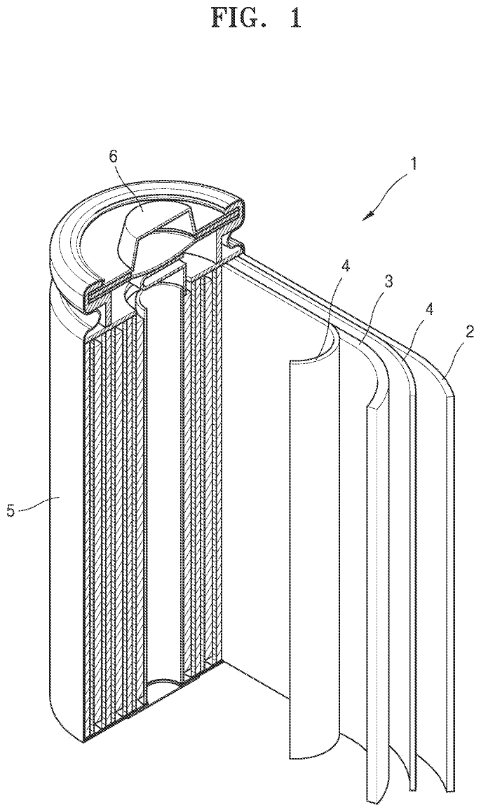

As shown in FIG. 1, a lithium battery 1 may include a positive electrode 3, a negative electrode 2, and a separator 4. The positive electrode 3, the negative electrode 2, and the separator 4 may be wound or folded and accommodated in a battery case 5. Subsequently, an electrolyte may be injected into the battery case 5, and the battery case 5 may be sealed with a cap assembly 6 to complete the lithium battery 1. The battery case 5 may have a cylindrical shape, a prismatic shape, a thin film shape, and/or the like. For example, the lithium battery 1 may be a large-sized thin film battery. The lithium battery 1 may be a lithium ion battery.

The separator 4 may be provided between the positive electrode 3 and the negative electrode 2 to form a battery structure. The battery structure may be stacked in a bi-cell structure and then impregnated in an organic electrolyte, and an obtained result may be accommodated in a pouch and sealed, thereby completing a lithium ion polymer battery.

In some embodiments, a plurality of battery structures may be stacked to form a battery pack, and such a battery pack may be utilized in all devices requiring high capacity and high power. For example, the battery pack may be utilized in a laptop computer, a smartphone, an electric vehicle, and/or the like.

In a lithium secondary battery according to one or more embodiments, an increase in direct current internal resistance (DC-IR) may be considerably reduced as compared with a lithium secondary battery adopting general nickel-rich lithium-nickel composite oxide as a positive electrode active material, thereby exhibiting excellent or suitable battery characteristics.

An operating voltage of a lithium secondary battery to which the positive electrode 3, the negative electrode 2, and the electrolyte are applied may have, for example, a lower limit of about 2.5 V to about 2.8 V and an upper limit of about 4.1 V or more, and may be, for example, in a range of about 4.1 V to about 4.45 V.

In some embodiments, the lithium secondary battery may be utilized in, for example, a power tool that moves by receiving power from an electric motor, an electric motor vehicle such as an electric vehicle (EV), a hybrid electric vehicle (HEV), or a plug-in hybrid electric vehicle (PHEV), an electric two-wheeled vehicle such as an electric bike (E-bike) or an electric scooter (E-scooter), an electric golf cart, a power storage system, and/or the like, but one or more embodiments are not limited thereto.

As utilized herein, the term “alkyl group” may refer to a branched or unbranched aliphatic hydrocarbon group. In one or more embodiments, the alkyl group may be substituted or unsubstituted. Examples of the alkyl group may include a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, a cycloheptyl group, and/or the like, but one or more embodiments are not limited thereto. In other embodiments, each of the examples of the alkyl group may be optionally substituted. In other embodiments, the alkyl group may have 1 to 6 carbon atoms. For example, a C1-C6 alkyl group may include a methyl group, an ethyl group, a propyl group, an isopropyl group, a butyl group, an isobutyl group, a sec-butyl group, a pentyl group, a 3-pentyl group, a hexyl group, and/or the like, but one or more embodiments are not limited thereto.

At least one hydrogen atom of alkyl may be substituted with a halogen atom, a C1-C20 alkyl group substituted with a halogen atom (for example, CCF₃, CHCF₂, CH₂F, or CCl₃), a C1-C20 alkoxy group, a C2-C20 alkoxyalkyl group, a hydroxyl group, a nitro group, a cyano group, an amino group, an amidino group, hydrazine, hydrazone, a carboxyl group or a salt thereof, a sulfonyl group, a sulfamoyl group, a sulfonic acid or a salt thereof, a phosphoric acid or a salt thereof, a C1-C20 alkyl group, a C2-C20 alkenyl group, a C2-C20 alkynyl group, a C1-C20 heteroalkyl group, a C6-C20 aryl group, a C7-C20 arylalkyl group, a C6-C20 heteroaryl group, a C7-C20 heteroarylalkyl group, a C6-C20 heteroaryloxy group, or a C6-C20 heteroaryloxyalkyl group.

As utilized herein, the term “alkenyl group” may refer to a C2 to C20 hydrocarbon group having at least one carbon-carbon double bond. Examples of the alkenyl group may include an ethenyl group, a 1-prophenyl group, a 2-prophenyl group, a 2-methyl-1-prophenyl group, a 1-butenyl group, a 2-butenyl group, a cycloprophenyl group, cyclopentenyl, cyclohexenyl, cycloheptenyl, and/or the like, but one or more embodiments are not limited thereto. In other embodiments, the alkenyl group may be substituted or unsubstituted. In other embodiments, the alkenyl group may have 2 to 40 carbon atoms.

As utilized herein, the term “alkynyl group” may refer to a C2 to C20 hydrocarbon group having at least one carbon-carbon triple bond. Examples of the alkynyl group may include an ethynyl group, a 1-propynyl group, a 1-butynyl group, a 2-butynyl group, and/or the like, but one or more embodiments are not limited thereto. In other embodiments, the alkynyl group may be substituted or unsubstituted. In other embodiments, the alkynyl group may have 2 to 40 carbon atoms.

In the present specification, a substituent is derived from an unsubstituted parent group in which at least one hydrogen atom is substituted with another atom or a functional group. Unless otherwise indicated, if (e.g., when) a functional group is deemed to be “substituted,” it is meant that the functional group is substituted with at least one substituent independently selected from among a C₁-C₂₀ group, a C₂-C₂₀ alkenyl group, a C₂-C₂₀ alkynyl group, a C₁-C₂₀ alkoxy group, a halogen group, a CN group, a hydroxyl group, and a nitro group. If (e.g., when) a functional group is described as being “optionally substituted,” the functional group may be substituted with at least one selected from among the above-described substituents.

The term “halogen” may include fluorine, bromine, chlorine, iodine, and/or the like.

The term “alkoxy” may refer to “alkyl-O-”, and alkyl may be defined above. Examples of an alkoxy group may include a methoxy group, an ethoxy group, a 2-propoxy group, a butoxy group, a t-butoxy group, a pentyloxy group, a hexyloxy group, and/or the like. At least one hydrogen atom of the alkoxy may be substituted with the same substituent as the above-described alkyl group.

The term “heteroaryl” may refer to a monocyclic or bicyclic organic group including at least one heteroatom selected from among N, O, P, and S, wherein the remaining ring atoms are all carbon. A heteroaryl group may include, for example, one to five heteroatoms, and in some embodiments, may include a five- to ten-membered ring. S or N may be oxidized to have one or more suitable oxidation states.

Examples of the heteroaryl may include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isooxazol-3-yl, isooxazol-4-yl, isooxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, or 5-pyrimidin-2-yl.

The term “heteroaryl” may include a case in which a heteroaromatic ring is selectively fused to at least one of an aryl group, a cycloaliphatic group, or a heterocyclic group.

The term “carbon ring” may refer to a saturated or partially unsaturated non-aromatic monocyclic, bicyclic, or tricyclic hydrocarbon group.

Examples of monocyclic hydrocarbon may include cyclopentyl, cyclopentenyl, cyclohexyl, cyclohexenyl, and/or the like.

Examples of bicyclic hydrocarbon may include bornyl, decahydronaphthyl, bicyclo[2.1.1]hexyl, bicyclo[2.2.1]heptyl, bicyclo[2.2.1]heptenyl, or bicyclo[2.2.2]octyl.

Examples of tricyclic hydrocarbon may include adamantly and/or the like.

At least one hydrogen atom in the carbon ring may be substituted with a substituent similar to the above-described alkyl group.

Hereinafter, the disclosure will be described in more detail through the following Examples and Comparative Examples. However, the following Examples and Comparative Examples are merely presented to exemplify the disclosure, and the scope of the disclosure is not limited thereto.

### EXAMPLES

### Preparation of Additive for Electrolyte

### Preparation Example 1: Synthesis of Compound A

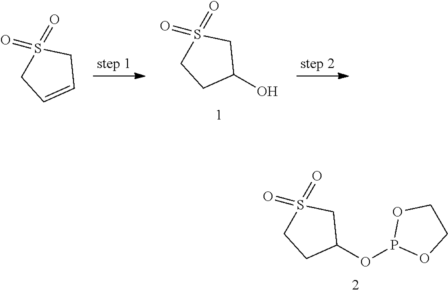 [SMILES: O=S1(=O)CC=CC1 ; O=S1(=O)CCC(O)C1 ; O=S1(=O)CCC(OP2OCCO2)C1]

5 g (42.2 mmol) of 3-sulfolene and 2.6 g (46.6 mmol) of potassium hydroxide were dissolved in 8 mL of distilled water, heated, and stirred at a temperature of 40° C. for about 5 hours. After a reaction mixture was cooled to room temperature, a solution was neutralized with a 35 wt % to 37 wt % concentrated hydrochloric acid aqueous solution (pH 6 to pH 7).

A mixture obtained according to such a process was poured into cold acetone to filter and remove a precipitated potassium chloride salt and concentrate a filtrate. A crude product obtained through such a process was dissolved in a small amount of acetone, was allowed to pass through a silica gel utilizing ethyl acetate as a developing solution, and then concentrated to obtain Compound 1 in a white solid state.

### Synthesis of Compound A

3 g (7.34 mmol) of Compound 1 was dissolved in 100 mL of methylene chloride, and 2.45 g of triethylamine was added and stirred.

After 2.84 g of 2-chloro-1,3,2-dioxaphospholane was slowly added drop by drop to such a solution, a reaction was performed for about 5 hours to filter a generated precipitate and concentrate a filtrate. A concentrated liquid was recrystallized to obtain Compound 2 (Compound A) in a white solid state.

### Preparation Example 2: Synthesis of Compound E

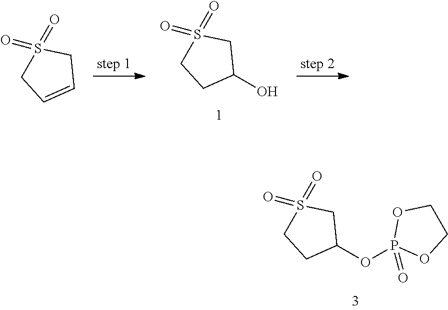 [SMILES: O=S1(=O)CC=CC1 ; O=S1(=O)CCC(O)C1 ; O=P1(OC2CCS(=O)(=O)C2)OCCO1]

### Synthesis of Compound 1

5 g (42.2 mmol) of 3-sulfolene and 2.6 g (46.6 mmol) of potassium hydroxide were dissolved in 8 mL of distilled water, heated, and stirred at a temperature of 40° C. for about 5 hours. After a reaction mixture was cooled to room temperature, a solution was neutralized with a 35 wt % to 37 wt % concentrated hydrochloric acid aqueous solution (pH 6 to pH 7). A mixture was poured into cold acetone to filter and remove a precipitated potassium chloride salt, and a filtrate was concentrated. An obtained crude product was dissolved in a small amount of acetone, allowed to pass through a silica gel utilizing ethyl acetate as a developing solution, and then concentrated to obtain Compound 1 in a white solid state.

3 g (7.34 mmol) of Compound 1 was dissolved in 100 mL of methylene chloride, and 2.45 g of triethylamine was added and stirred.

After 3.20 g of 2-chloro-1,3,2-dioxaphospholane 2-oxide was slowly added drop by drop to such a solution, a reaction was performed for about 5 hours to filter a generated precipitate and concentrate a filtrate. A concentrated liquid was recrystallized to obtain Compound 2 (Compound E) in a white solid state.

### Preparation of Electrolyte

### Comparative Example 1

1.5 M Li PF₆ was added to a mixed solvent of ethylene carbonate (EC), ethyl methyl carbonate (EMC), and dimethyl carbonate (DMC) having a volume ratio of 20:10:70 to prepare an electrolyte.

### Comparative Example 2

With respect to 100 wt % of the total weight of the electrolyte of Comparative Example 1, 1 wt % of Compound I was added as an additive.

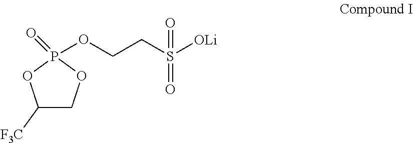

### Comparative Example 3

With respect to 100 wt % of the total weight of the electrolyte of Comparative Example 1, 1 wt % of Compound J was added as an additive.

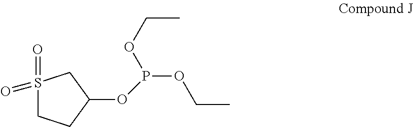

### Example 1

With respect to 100 wt % of the total weight of the electrolyte of Comparative Example 1, 0.2 wt % of Compound A was added as an additive to prepare an electrolyte.

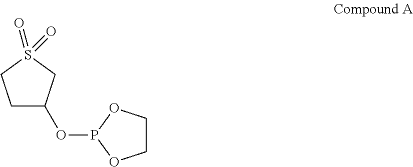 [SMILES: O=S1(=O)CCC(OP2OCCO2)C1]

### Examples 2 and 3

Electrolytes were prepared in substantially the same manner as in Example 1, except that contents of Compound A as an additive were changed into 0.5 wt % and 1.0 wt %, respectively.

### Example 4

With respect to 100 wt % of the total weight of the electrolyte of Comparative Example 1, 0.2 wt % of Compound E was added as an additive to prepare an electrolyte.

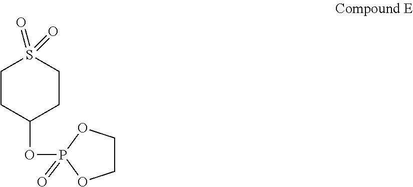 [SMILES: O=P1(OC2CCS(=O)(=O)CC2)OCCO1]

### Examples 5 and 6

Electrolytes were prepared in substantially the same manner as in Example 4, except that contents of Compound E as an additive were changed into 0.5 wt % and 1.0 wt %, respectively.

### Manufacturing of Lithium Secondary Battery (Pouch Cell)

### Manufacturing Example 1

98 wt % of graphite particles, 1 wt % of carboxylmethylcellulose (CMC), and 1 wt % of a styrene-butadiene rubber (SBR) aqueous dispersion binder were mixed, put into distilled water, and then stirred for 60 minutes utilizing a mechanical stirrer to prepare slurry of a negative active material. The slurry was applied to a thickness of about 60 micrometer (μm) on a copper current collector with a thickness of 10 μm utilizing a doctor blade, dried in a hot air dryer at a temperature of 100° C. for 0.5 hours, dried once more for 4 hours under conditions of vacuum and a temperature of 120° C., and then roll-pressed to prepare a negative electrode. A mixture density (E/D) of the negative electrode was 1.55 g/cc, and a loading level (L/L) thereof was 14.36 milligram per square centimeter (mg/cm²).

Separately, a positive electrode was prepared according to the following process.

94 wt % of LiNi_{0.6}Co_{0.2}Mn_{0.2}O₂ (NCM 622 manufactured by Münster Electrochemical Energy Technology), 3.0 wt % of a conductive material (Denka black), and 3.0 wt % of a binder polyvinylidene fluoride (PVDF) were mixed, put into an N-methyl-2-pyrrolidone solvent, and then stirred for 30 minutes utilizing a mechanical stirrer to prepare slurry of a positive electrode active material. The slurry was applied to a thickness of about 60 μm on an aluminum current collector with a thickness of 20 μm utilizing a doctor blade, dried in a hot air dryer at a temperature of 100° C. for 0.5 hours, dried once more for 4 hours under conditions of vacuum and a temperature of 120° C., and then roll-pressed to prepare the positive electrode. A mixture density (E/D) of the positive electrode was 3.15 gram per cubic centimeter g/cc, and a loading level (L/L) thereof was 27.05 mg/cm ².

A lithium secondary battery (pouch cell having about 40 milliampere hour (mAh)) was manufactured utilizing a polyethylene separator (thickness of 16 μm) as a separator and utilizing the electrolyte of Example 3 as an electrolyte.

### Manufacturing Examples 2 to 6

Lithium secondary batteries (pouch cells) were manufactured in substantially the same manner as in Manufacturing Example 1, except that the electrolytes prepared in Examples 4 to 9 were utilized instead of the electrolyte prepared in Example 3.

### Comparative Manufacturing Examples 1 to 3

Lithium secondary batteries (pouch cells) were manufactured in substantially the same manner as in Manufacturing Example 1, except that the electrolytes prepared in Comparative Examples 1 to 3 were utilized instead of the electrolyte prepared in Example 3.

### Evaluation Example 1: Gas Generation Amount after High-Temperature Storage

The lithium secondary batteries manufactured according to Manufacturing Examples 1 to 6 and Comparative Manufacturing Example 1 were fully charged at 25° C. (state of charge (SOC) 100), stored in an oven at a temperature of 60° C. for 10 days, 20 days, or 30 days, and then fully discharged again (SOC 0). Then, for the lithium secondary batteries, a gas generation amount and a gas reduction rate were measured utilizing a refinery gas analyzer (RGA). Results thereof are shown in Table 1. Here, SOC 100 is a state in which a battery is charged to have a charge capacity of 100% if (e.g., when) the total charge capacity of the battery is 100% and this state refers to a state in which discharging is 0% if (e.g., when) viewed as a discharge state.

Describing charge/discharge conditions, the lithium secondary batteries were cut-off charged at 0.33 coulomb (C) up to 4.2 volt (V) under a constant current (CC) condition at a temperature of 25° C. and cut off-charged at 0.05 C under a constant voltage (CV) condition to perform CC/CV charging and then were cut-off discharged at 0.33 C down to 2.5 V.

gas reduction rate (%)={(gas generation amount of Comparative Manufacturing Example 1-gas generation amount of sample)/(gas generation amount of Comparative Manufacturing Example 1)}×100 Equation 1

TABLE 1

| | Composition | Gas generation | Gas reduction |
|---|---|---|---|
| Classification | of additive | amount (mL) | rate (%) |
| Comparative | — | 1.23 | 0 |
| Manufacturing | | | |
| Example 1 | | | |
| Manufacturing | 0.2 wt % of | 1.12 | 8.9 |
| Example 1 | Compound A | | |
| Manufacturing | 0.5 wt % of | 1.04 | 15.4 |
| Example 2 | Compound A | | |
| Manufacturing | 1.0 wt % of | 1.00 | 18.7 |
| Example 3 | Compound A | | |
| Manufacturing | 0.2 wt % of | 1.06 | 13.8 |
| Example 4 | Compound E | | |
| Manufacturing | 0.5 wt % of | 1.02 | 17.1 |
| Example 5 | Compound E | | |
| Manufacturing | 1 wt % of | 0.96 | 22.0 |
| Example 6 | Compound E | | |

As shown in Table 1, it may be seen that a gas generation amount of the lithium secondary batteries of Manufacturing Examples 1 to 6 was reduced as compared with the case of Comparative Manufacturing Example 1.

### Manufacturing Example 3 and Comparative Manufacturing Examples 1 to 3

A gas generation amount after high-temperature storage for the lithium secondary batteries manufactured according to Manufacturing Example 3 and Comparative Manufacturing Examples 1 to 3 was evaluated under the same evaluation conditions as the gas generation amount after high-temperature storage for the lithium secondary batteries manufactured according to Manufacturing Example 1 and Comparative Manufacturing Example 1. Results thereof are shown in Table 2.

TABLE 2

| | Composition | Gas generation | Gas reduction |
|---|---|---|---|
| Classification | of additive | amount (mL) | rate (%) |
| Comparative | — | 1.23 | 0 |
| Manufacturing | | | |
| Example 1 | | | |
| Manufacturing | 1.0 wt % of | 1.00 | 18.7 |
| Example 3 | Compound A | | |
| Comparative | 1 wt % of | 1.08 | 12.1 |
| Manufacturing | Compound I | | |
| Example 2 | | | |
| Comparative | 1 wt % of | 1.10 | 10.2 |
| Manufacturing | Compound J | | |
| Example 3 | | | |

Referring to Table 2, it can be seen that a gas reduction rate of the lithium secondary battery of Manufacturing Example 3 was increased as compared with the case of Comparative Manufacturing Examples 2 and 3.

### Evaluation Example 2: Resistance Increase Rate after High-Temperature Storage

Each of the lithium secondary batteries manufactured according to Manufacturing Examples 1 to 6 and Comparative Manufacturing Examples 1 to 3 was cut-off charged at 0.33 C up to 4.2 V under a CC condition at a temperature of 25° C., cut-off charged at 0.05 C under a CV condition, and then cut-off discharged at 0.33 C down to 2.5 V. In this case, under an SOC condition set to SOC 100 (that is a state in which a battery is charged to have a charge capacity of 100% if (e.g., when) the total charge capacity of the battery is 100% and refers to a state in which the battery is not at all discharged in terms of a discharge state), a voltage drop (V) occurring if (e.g., when) a current flowed at 1 C for 10 seconds was measured to calculate (DC-IR).

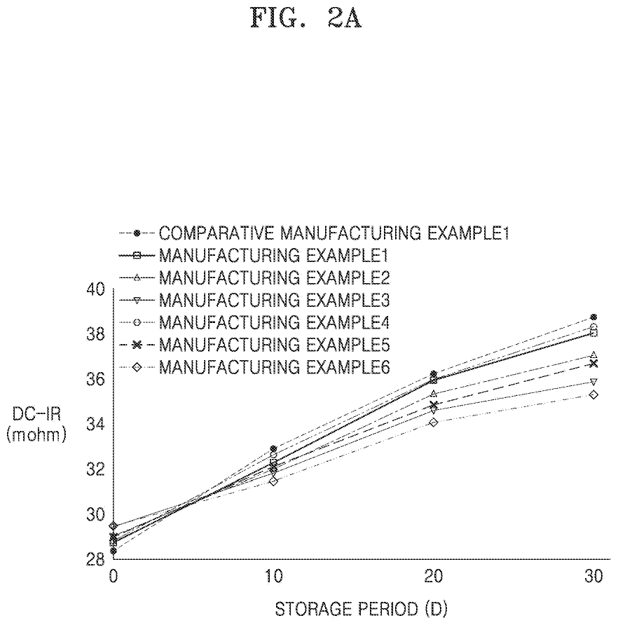

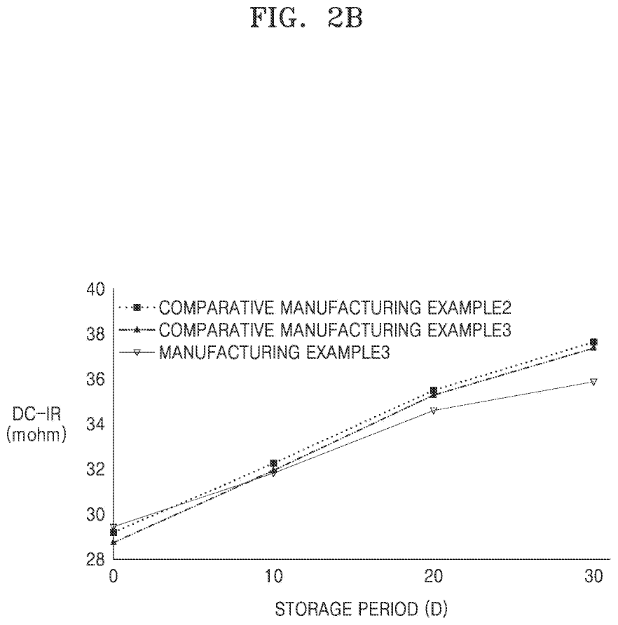

Each of the lithium secondary batteries was left at a temperature of 60° C. for 10 days, 20 days, and 30 days in an SOC (=100%) and then evaluated about a resistance increase rate according to formula 2 if (e.g., when) left at a high temperature (60° C.). Results thereof are shown in Table 2 and FIGS. 2A and 2B. Here, a resistance increase rate (%) is a percentage of DC-IR after leaving for 30 days relative to initial DC-IR.

TABLE 3

| | Composition | DC-IR [mohm] | | | | ΔDC-IR increase rate [%] | | | |
|---|---|---|---|---|---|---|---|---|---|
| Classification | of additive | 0 d | 10 d | 20 d | 30 d | 0 d | 10 d | 20 d | 30 d |
| Manufacturing | 0.2 wt % of | 28.77 | 32.31 | 35.93 | 38.06 | 100.0 | 112.3 | 124.9 | 132.3 |
| Example 1 | Compound A | | | | | | | | |
| Manufacturing | 0.5 wt % of | 29.05 | 32.01 | 35.32 | 37.07 | 100.0 | 110.2 | 121.6 | 127.6 |
| Example 2 | Compound A | | | | | | | | |
| Manufacturing | 1.0 wt % of | 29.46 | 31.85 | 34.62 | 35.88 | 100.0 | 108.1 | 117.5 | 121.8 |
| Example 3 | Compound A | | | | | | | | |
| Manufacturing | 0.2 wt % of | 28.85 | 32.66 | 36.00 | 38.34 | 100.0 | 113.2 | 124.8 | 132.9 |
| Example 4 | Compound E | | | | | | | | |
| Manufacturing | 0.5 wt % of | 29.16 | 32.31 | 35.05 | 36.89 | 100.0 | 110.8 | 120.2 | 126.5 |
| Example 5 | Compound E | | | | | | | | |
| Manufacturing | 1.0 wt % of | 29.51 | 31.49 | 34.11 | 35.32 | 100.0 | 106.7 | 115.6 | 119.7 |
| Example 6 | Compound E | | | | | | | | |
| Comparative | No additive | 28.42 | 32.91 | 36.26 | 38.76 | 100.0 | 115.8 | 127.6 | 136.4 |
| Manufacturing | | | | | | | | | |
| Example 1 | | | | | | | | | |
| Comparative | 1.0 wt % of | 29.21 | 32.25 | 35.49 | 37.65 | 100.0 | 110.4 | 121.5 | 128.9 |
| Manufacturing | Compound I | | | | | | | | |
| Example 2 | | | | | | | | | |
| Comparative | 1.0 wt % of | 28.74 | 31.96 | 35.29 | 37.39 | 100.0 | 111.2 | 122.8 | 130.1 |
| Manufacturing | Compound J | | | | | | | | |
| Example 3 | | | | | | | | | |

In Table 2, 0 d, 10 d, 20 d, and 30 d represent 0 days, 10 days, 20 days, and 30 days, respectively.

As shown in Table 2 and FIG. 2A, as compared with the case of Comparative Manufacturing Example 1 not utilizing an additive for an electrolyte, the lithium secondary batteries of Manufacturing Examples 1 to 6 utilizing Compound A or Compound E as an electrolyte additive had small resistance increase rates during high-temperature storage, and thus high-temperature storage characteristics were improved.

In some embodiments, as shown in FIG. 2B, the lithium secondary battery of Manufacturing Example 3 had reduced resistance increase rate during high-temperature storage as compared with Comparative Manufacturing Examples 2 and 3.

### Evaluation Example 3: High-Temperature (45° C.) Life Characteristics

In the lithium secondary batteries manufactured according to Manufacturing Examples 1 to 6 and Comparative Manufacturing Examples 1 to 3, the lithium secondary batteries subjected to a formation operation were charged at a CC rate of 0.33 C and a temperature of 45° C. until a voltage reached 4.2 V (vs. Li), and then, in a CV mode, while 4.2 V was maintained, the charging was cut off at a current rate of 0.05 C. Subsequently, the lithium secondary batteries were discharged at a CC rate of 1.0 C until the voltage reached 2.5 V (vs. Li) during discharging. Such a charging/discharging cycle was repeated 300 times.

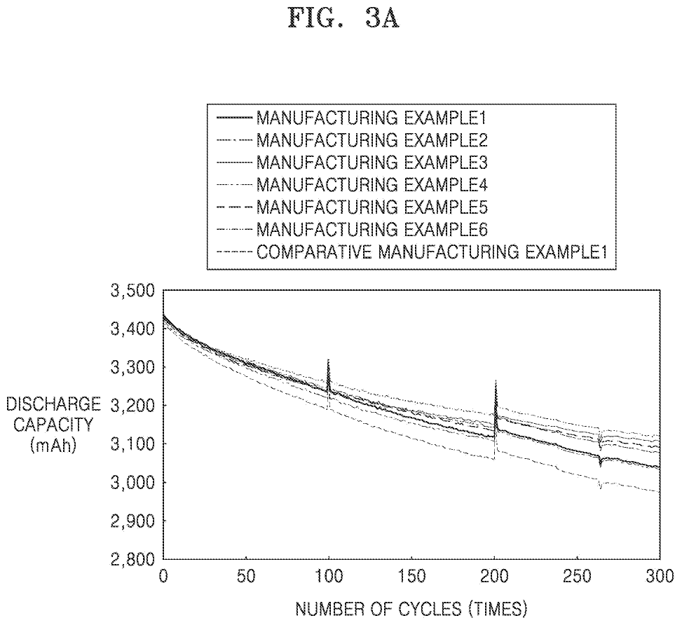

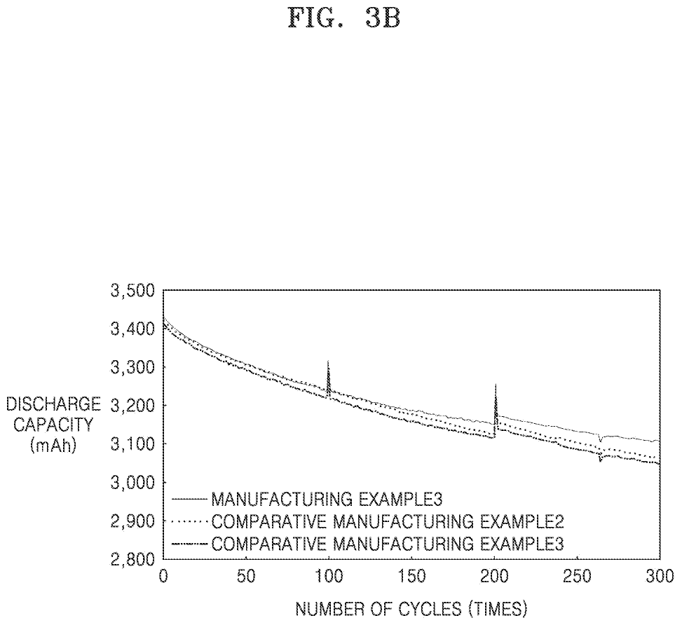

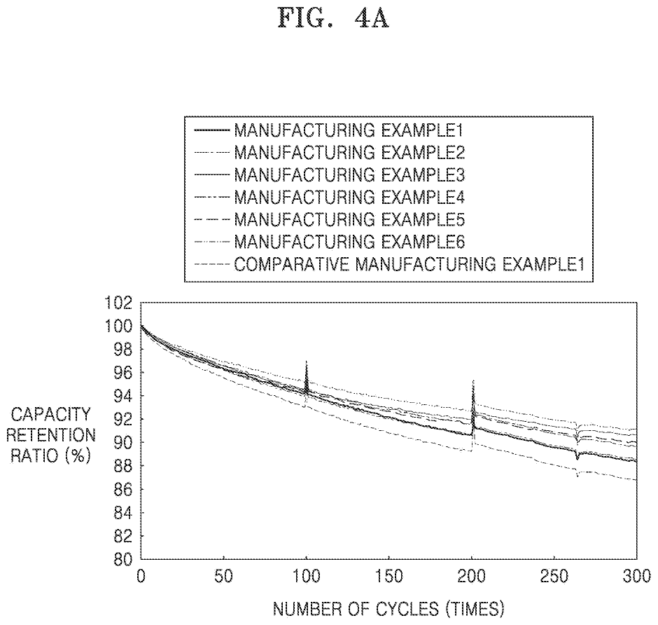

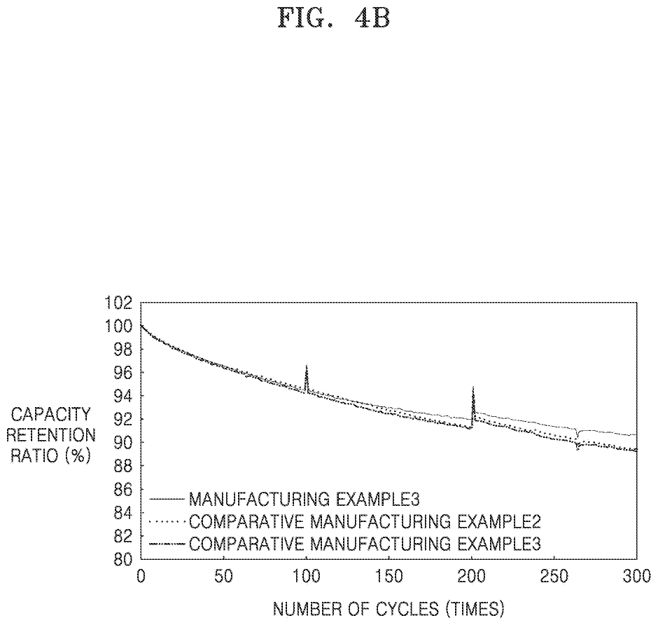

The lithium batteries were rested for 10 minutes after every charging/discharging cycle. Results thereof are shown in FIGS. 3A, 3B, 4B, and 4B. Here, a capacity retention ratio at a 300^{th} cycle is defined by Equation 2. FIGS. 3A and 3B show a change in discharge capacity according to the number of cycles of each lithium secondary battery, and FIGS. 4A and 4B show a capacity retention ratio according to the number of cycles of each lithium secondary battery.

capacity retention ratio (%)=[discharge capacity at 300^{th} cycle/discharge capacity at first cycle]×100 Equation 2

As shown in FIGS. 3A and 4A, in the lithium secondary batteries of Manufacturing Examples 1 to 6 utilizing an electrolyte that included the additives for an electrolyte of Examples 1 to 6, it may be seen that high-temperature life characteristics were improved as compared with the case of Comparative Manufacturing Example 1 utilizing an electrolyte that did not include an additive for an electrolyte.

In some embodiments, as shown in FIGS. 3B and 4B, in the lithium secondary battery of Manufacturing Example 3, it may be seen that high-temperature life characteristics were improved as compared with the lithium secondary batteries of Comparative Manufacturing Examples 2 and 3.

An electrolyte for a lithium secondary battery according to one or more embodiments is oxidatively decomposed during formation to form a cathode electrolyte interface (CEI) film on a positive electrode, thereby protecting the positive electrode and suppressing an increase in voltage of a battery to suppress or reduce electrolyte decomposition. Therefore, if (e.g., when) such an electrolyte is adopted, a positive electrode may be protected to provide a lithium secondary battery having improved safety, improved life characteristics at a high temperature, and improved safety during high-temperature stability.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the disclosure as defined by the following claims and equivalents thereof.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

While one or more embodiments have been described with reference to the drawings and Examples, the description merely illustrates, and it will be understood by those of ordinary skill in the art that one or more suitable modifications and other equivalent embodiments are possible therefrom. Therefore, the protection scope of the present disclosure should be defined by the appended claims and equivalents thereof.

What is claimed is:

1. An electrolyte for a lithium secondary battery, the electrolyte comprising:
a lithium salt;
an organic solvent; and
an additive represented by Formula 1 or Formula 2: 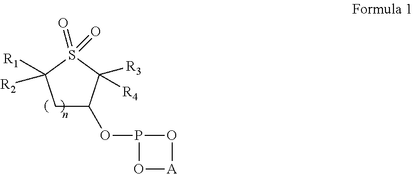
wherein, in Formula 1, A is —[C(R₅)(R₆)]ₘ—, R₁ to R₆ are each independently hydrogen, a substituted or unsubstituted C1-C20 alkyl group, a substituted or unsubstituted C1-20 alkoxy group, a substituted or unsubstituted C2-C20 alkenyl group, a substituted or unsubstituted C3-C20 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, n is an integer of 1 or 2, and m is an integer from 1 to 3, and 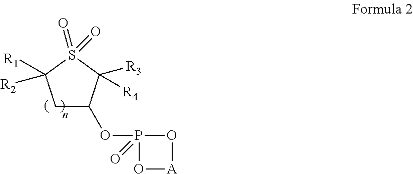
wherein, in Formula 2, A is —[C(R₅)(R₆)]ₘ—, R₁ to R₆ are each independently hydrogen, a substituted or unsubstituted C1-C20 alkyl group, a substituted or unsubstituted C1-20 alkoxy group, a substituted or unsubstituted C2-C20 alkenyl group, a substituted or unsubstituted C3-C20 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, n is an integer of 1 or 2, and m is an integer from 1 to 3.

2. The electrolyte as claimed in claim 1, wherein the additive represented by Formula 1 or Formula 2 is an additive represented by Formula 3, Formula 3-1, Formula 3-2, Formula 3-3, Formula 4, Formula 4-1, Formula 4-2, or Formula 4-3: 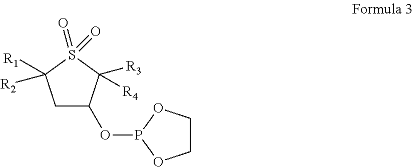
wherein, in Formula 3, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 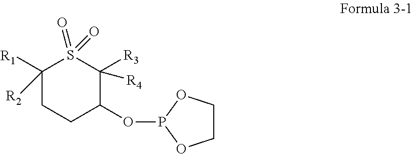
wherein, in Formula 3-1, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 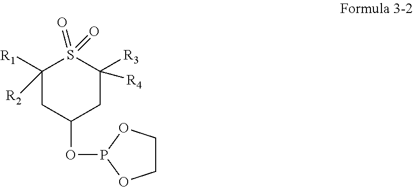
wherein, in Formula 3-2, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 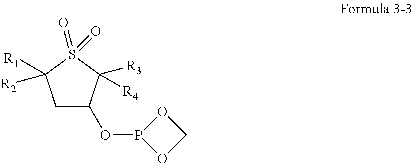
wherein, in Formula 3-3, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 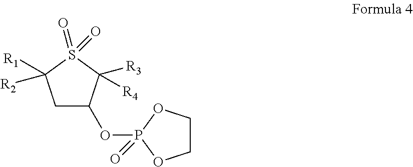
wherein, in Formula 4, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 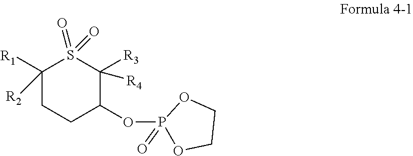
wherein, in Formula 4-1, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 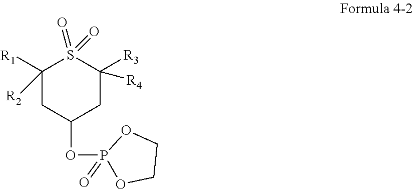
wherein, in Formula 4-2, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, and 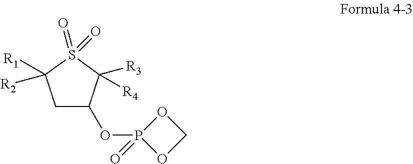
wherein, in Formula 4-3, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

3. The electrolyte as claimed in claim 1, wherein the additive is at least one selected from among Compounds A to H:

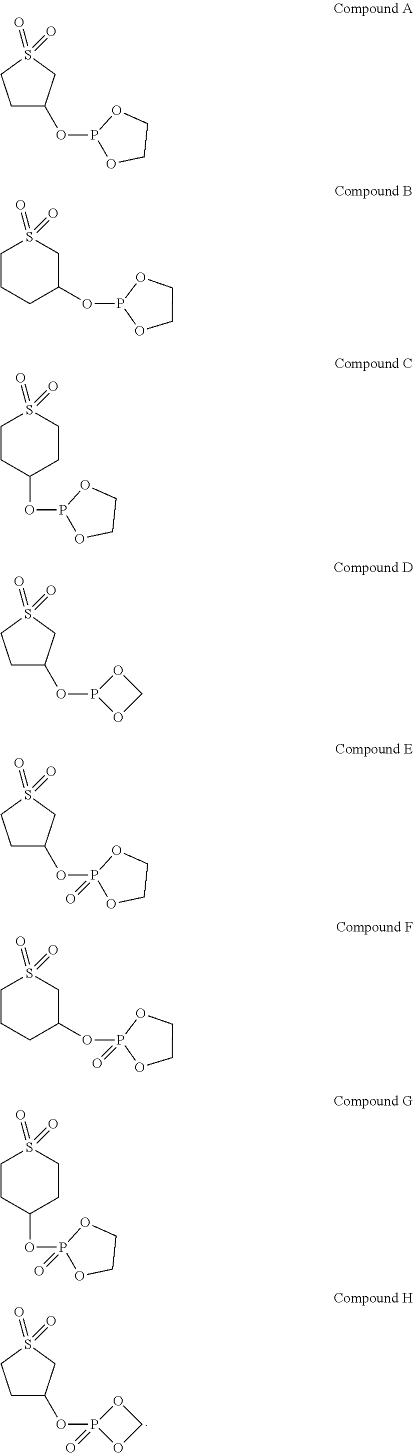

4. The electrolyte as claimed in claim 1, wherein an amount of the additive is in a range of about 0.1 wt % to about 10 wt % with respect to a total weight of the electrolyte.

5. The electrolyte as claimed in claim 1, wherein a concentration of the lithium salt is about 0.1 M to about 5.0 M.

6. The electrolyte as claimed in claim 1, wherein the lithium salt comprises at least one selected from among LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), LiPO₂F₂, and compounds represented by Formulas 5 to 8:

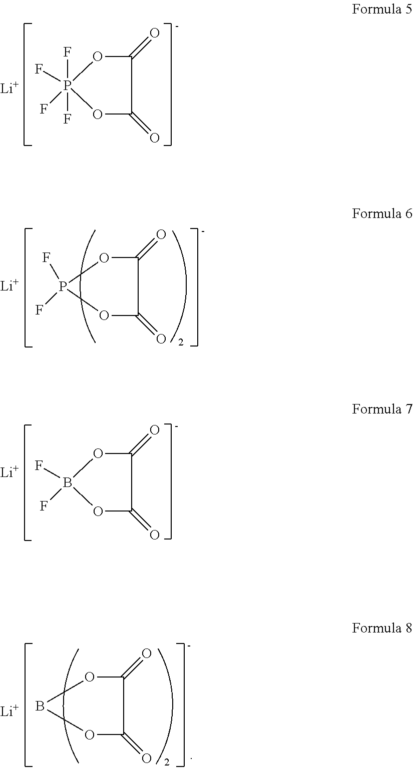

7. The electrolyte as claimed in claim 1, wherein the organic solvent comprises at least one selected from among ethyl methyl carbonate (EMC), methyl propyl carbonate, ethyl propyl carbonate, dimethyl carbonate (DMC), diethyl carbonate (DEC), dipropyl carbonate, propylene carbonate (PC), ethylene carbonate (EC), fluoroethylene carbonate (FEC), vinylene carbonate (VC), vinylethylene carbonate (VEC), butylene carbonate, ethyl propionate, ethyl butyrate, dimethyl sulfoxide, dimethylformamide, dimethylacetamide, gamma-valerolactone, gamma-butyrolactone, and tetrahydrofuran.

8. A lithium secondary battery comprising:
a positive electrode comprising a positive electrode active material;
a negative electrode comprising a negative electrode active material; and
the electrolyte as claimed in claim 1 between the positive electrode and the negative electrode.

9. The lithium secondary battery as claimed in claim 8, wherein the additive represented by Formula 1 or Formula 2 is an additive represented by Formula 3, Formula 3-1, Formula 3-2, Formula 3-3, Formula 4, Formula 4-1, Formula 4-2, or Formula 4-3: 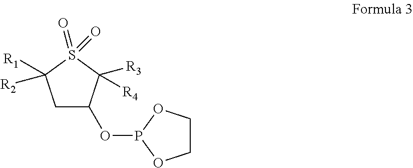
wherein, in Formula 3, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 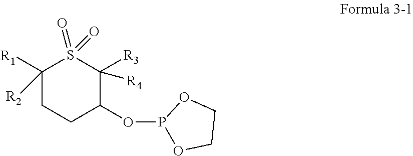
wherein, in Formula 3-1, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 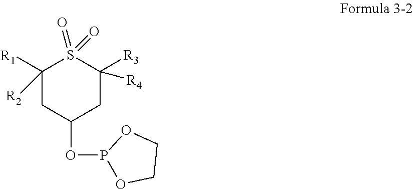
wherein, in Formula 3-2, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 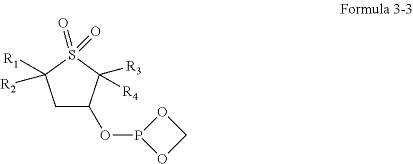
wherein, in Formula 3-3, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 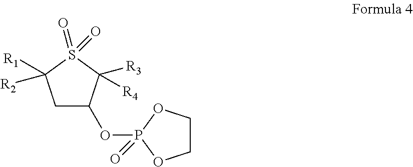
wherein, in Formula 4, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 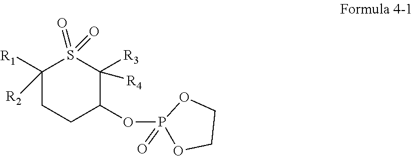
wherein, in Formula 4-1, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, 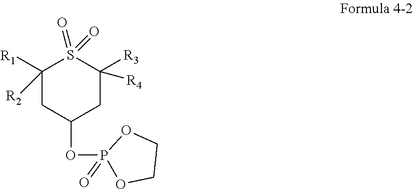
wherein, in Formula 4-2, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group, and 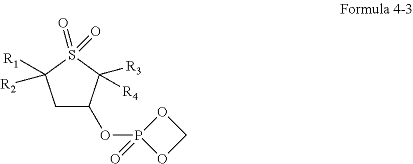
wherein, in Formula 4-3, R₁ to R₄ are each independently hydrogen, a substituted or unsubstituted C1-C5 alkyl group, a substituted or unsubstituted C1-C5 alkoxy group, a substituted or unsubstituted C2-C10 alkenyl group, a substituted or unsubstituted C3-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

10. The lithium secondary battery as claimed in claim 8, wherein the additive is at least one selected from among Compounds A to H:

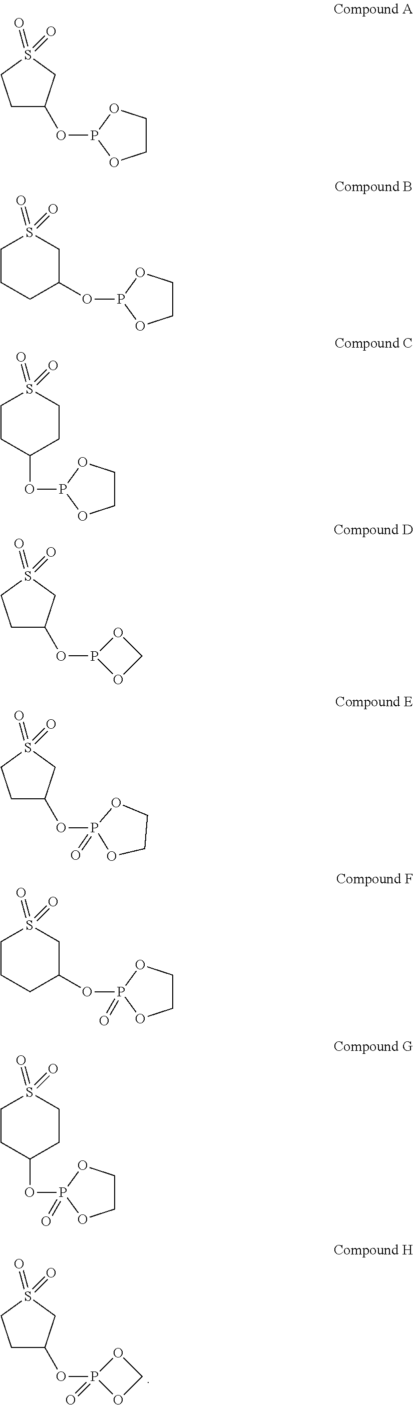

11. The lithium secondary battery as claimed in claim 8, wherein an amount of the additive is about 0.1 wt % to about 10 wt % with respect to a total weight of the electrolyte.

12. The lithium secondary battery as claimed in claim 8, wherein a concentration of the lithium salt is about 0.1 M to about 5.0 M.

13. The lithium secondary battery as claimed in claim 8, wherein the lithium salt comprises at least one selected from among LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), LiPO₂F₂, and compounds represented by Formulas 5 to 8: [chemical structure]
